(19) United States
(12) Patent Application Publication
(10) Pub. No.: US 2026/0130543 A1
(43) Pub. Date: May 14, 2026

(54) COOKING DEVICE

(71) Applicant: JILLION ASSET MANAGEMENT CO., LTD., TAICHUNG CITY (TW)

(72) Inventor: HSIANG-JU HO, TAICHUNG CITY (TW)

(21) Appl. No.: 19/262,852

(22) Filed: Jul. 8, 2025

(30) Foreign Application Priority Data
Nov. 13, 2024 (TW) 113143648

(51) Int. Cl. A47J 37/04

(52) U.S. Cl. CPC A47J 37/049

(57) ABSTRACT

A cooking device includes a furnace frame unit, a fuel rack unit, and a shielding unit. The furnace frame unit includes frame boards interconnected with each other and cooperatively defining an accommodation space. The fuel rack unit includes fuel rack sets. Each fuel rack set has a surrounding wall, a fuel chamber, frame separators, and an ash box. The surrounding wall of each fuel rack set includes two side frame members, a bottom plate member, a top plate member, and a back panel member. The frame separators divide the fuel chamber into accommodating chambers. The side frame members and the frame separators are meshed. Each side frame member and each frame separator has mesh holes. The shielding unit surrounds the furnace frame unit and the fuel rack unit, and includes cover plates interconnected with each other and respectively disposed on outer sides of the fuel rack sets.

### CROSS-REFERENCE TO RELATED APPLICATION

This application claims priority to Taiwanese Invention Patent Application No. 113143648, filed on Nov. 13, 2024, the entire disclosure of which is incorporated by reference herein.

### FIELD

The disclosure relates to a cooking device, and more particularly to a barbecue cooking device.

### BACKGROUND

A conventional foldable barbecue grill (as disclosed in Taiwanese Patent No. I462713B) includes a first shell cover, a second shell cover, a first support leg, a second support leg, and a first tray body. The foldable barbecue grill is switchable between a folded position and an unfolded position. When the conventional foldable barbecue grill is in the folded position, the first shell cover and the second shell cover are close to each other, the first tray body is disposed between the first shell cover and the second shell cover, and the first support leg and the second support leg are close to each other, thereby preventing the first shell cover and the second shell cover from automatically unfolding. When the conventional foldable barbecue grill is in the unfolded position, each of the first support leg and the second support leg stands on a ground or a table, and the first tray body is hung between a first support shaft and a second support shaft, thereby enabling quick use of the conventional foldable barbecue grill.

Although the above-mentioned conventional foldable barbecue grill has a folding function, because charcoals are placed on the first tray body, and food ingredients such as meat and seafood are placed on a second tray body above the first tray body, when the food ingredients are coated with seasoning sauce, the seasoning sauce or oil from the food ingredients may drip onto the charcoals, thereby producing smoke, which not only makes a user uncomfortable but also causes poor air quality in the surrounding environment.

### SUMMARY

Therefore, an object of the disclosure is to provide a cooking device that can alleviate at least one of the drawbacks of the prior art.

According to the disclosure, the cooking device includes a furnace frame unit, a fuel rack unit, and a shielding unit.

The furnace frame unit includes a plurality of frame boards that are interconnected with each other. The frame boards cooperatively define an accommodation space. Each of the frame boards has an inner side surface, an outer side surface that is opposite to the inner side surface, and a penetrating region that communicates the inner side surface and the outer side surface. The fuel rack unit includes a plurality of fuel rack sets each of which is disposed on the outer side surface of a respective one of the frame boards. Each of the fuel rack sets has a surrounding wall, a fuel chamber that is formed by the surrounding wall, a plurality of frame separators, and an ash box that is detachably mounted on the surrounding wall and that is located at a bottom portion of the fuel chamber. The surrounding wall of each of the fuel rack sets includes two side frame members, a bottom plate member that interconnects the side frame members, a top plate member that interconnects the side frame members, and a back panel member that interconnects the side frame members, the bottom plate member and the top plate member. Each of the side frame members of the surrounding wall of each of the fuel rack sets has a plurality of support members that are disposed spaced apart. The frame separators of each of the fuel rack sets straddle the side frame members of the surrounding wall of the fuel rack set. Each of the frame separators of each of the fuel rack sets is disposed on one of the support members of one of the side frame members of the fuel rack set and a respective one of the support members of another one of the side frame members of the fuel rack set that is aligned with the one of the side frame members. The frame separators of each of the fuel rack sets divide the fuel chamber of the fuel rack set into a plurality of accommodating chambers. One of the accommodating chambers of each of the fuel rack sets that is located at a bottommost portion of the fuel chamber of the fuel rack set allows the ash box of the fuel rack set to be detachably mounted thereto. The side frame members and the frame separators are meshed. Each of the side frame members and the frame separators has a plurality of mesh holes. The shielding unit surrounds the furnace frame unit and the fuel rack unit, and includes a plurality of cover plates that are interconnected with each other and that are respectively disposed on outer sides of the fuel rack sets. Each of the cover plates has a plurality of vent holes that are in spatial communication with corresponding ones of the mesh holes of a corresponding one of the side frame members.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of an embodiment of a cooking device according to the present disclosure.

FIG. 2 is an exploded perspective view of the embodiment.

FIG. 3 is a fragmentary enlarged perspective view of FIG. 2.

FIG. 4 is a top view of the embodiment.

FIG. 5 is a sectional view taken along line V-V of FIG. 4.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

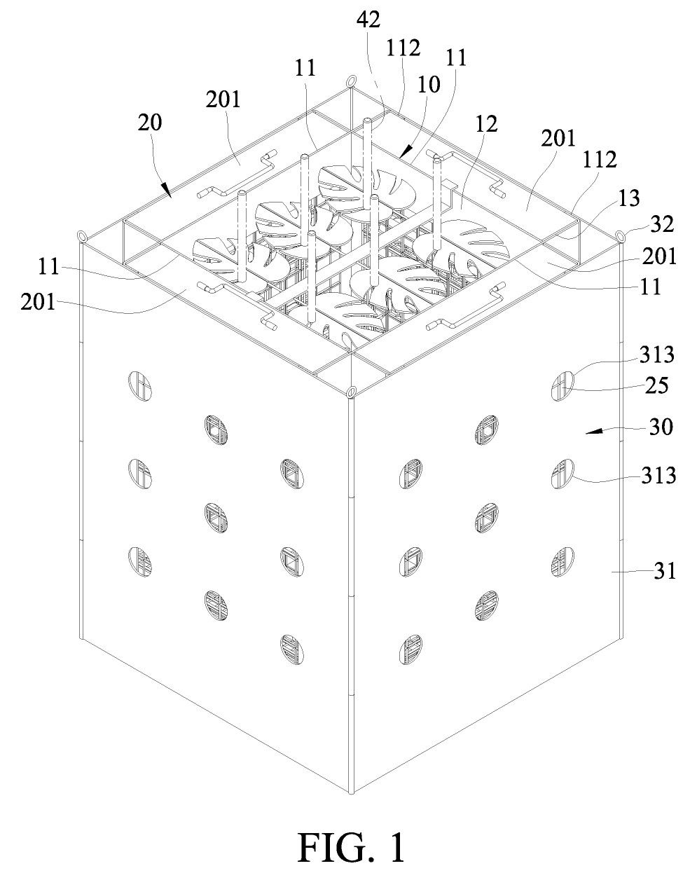

Referring to FIGS. 1-3, an embodiment of the cooking device according to the disclosure includes a furnace frame unit 10, a fuel rack unit 20, a shielding unit 30, a hanging unit 40, and an oil collection tank 50.

The furnace frame unit 10 includes a plurality of frame boards 11 that are interconnected with each other. The frame boards 11 cooperatively define an accommodation space 12 (the frame boards 11 surround the accommodation space 12). Each of the frame boards 11 has a plate body 111, two bent portions 112 that are integrally connected to the plate body 111, and a net body 113 that is connected to the plate body 111. The plate body 111 and the bent portions 112 are formed by bending a thin metal plate. The plate body 111 has an inner side surface 114, an outer side surface 115 that is opposite to the inner side surface 114, a penetrating region 116 that communicates the inner side surface 114 and the outer side surface 115, and two insert grooves 117 that are respectively provided on two sides of the penetrating region 116. The penetrating region 116 is disposed on the plate body 111. The net body 113 is disposed on the penetrating region 116. In this embodiment, a number of the frame boards 11 is four. The insert grooves 117 of two of the frame boards 11 that are opposite to each other have openings that face downward, and the insert grooves 117 of another two of the frame boards 11 that are opposite to each other have openings that face upward. Each of the frame boards 11 is connected to an adjacent one of the frame boards 11 by being inserted into one of the insert grooves 117 of the adjacent one of the frame boards 111. When the frame boards 11 are interconnected with each other (i.e., being assembled), any three adjacent ones of the frame boards 11 cooperatively define an outer space 13 that is located at one side of a middle one of the three adjacent ones of the frame boards 11 opposite to the accommodation space 12 (i.e., the frame boards 11 cooperatively define four outer spaces 13), and one of the bent portions 112 of each of another two of the three adjacent ones of the frame boards 11 that are opposite to each other is located at an outer opening of the outer space 13 distal from the accommodation space 12.

The fuel rack unit 20 includes a plurality of fuel rack sets 201, each of which is disposed on the outer side surface 115 of a respective one of the frame boards 11. The fuel rack sets 201 may be detachably and respectively inserted into the outer spaces 13. Each of the fuel rack sets 201 has a surrounding wall 21, a fuel chamber 22 that is formed by the surrounding wall 21, a plurality of frame separators 23, and an ash box 24 that is detachably mounted on the surrounding wall 21 and that is located at a bottom portion of the fuel chamber 22. The surrounding wall 21 of each of the fuel rack sets 21 includes two side frame members 211, a bottom plate member 212 that interconnects the side frame members 211, a top plate member 213 that interconnects the side frame members 211, and a back panel member 214 that interconnects the side frame members 211, the bottom plate member 212 and the top plate member 213. Each of the side frame members 211 has a plurality of support members 215 that are disposed spaced apart. The frame separators 23 of each of the side fuel rack sets 201 straddle the side frame members 211 of the surrounding wall 21 of the fuel rack set 201. Each of the frame separators 23 are disposed on one of the support members 215 of one of the side frame members 211 and a respective one of the support members 215 of another one of the side frame members 211 that is aligned with the one of the side frame members 211. The frame separators 23 divide the fuel chamber 22 into a plurality of accommodating chambers 221. One of the accommodating chambers 221 that is located at a bottommost portion of the fuel chamber 22 allows the ash box 24 to be detachably mounted thereto. The side frame members 211 and the frame separators 23 are meshed, and each of the side frame members 211 and the frame separators 23 has a plurality of mesh holes 25. Other ones of the accommodating chambers 221 that are located above the ash box 24 may be used for placement of a plurality of charcoals 60 therein.

The shielding unit 30 surrounds the furnace frame unit 10 and the fuel rack units 20, and includes a plurality of cover plates 31 that are interconnected with each other and that are respectively disposed on outer sides of the fuel rack sets 201, and a plurality of pivot shafts 32. Each of the cover plates 31 of the shielding unit 30 has two side edges 311, a plurality of connecting barrels 312 that are disposed on the side edges 311, and a plurality of vent holes 313 that are in spatial communication with the mesh holes 25 of a corresponding one of the side frame members 211. The connecting barrels 312 on one of the side edges 311 of one of any two adjacent ones of the cover plates 31 and the connecting barrels 312 on one of the side edges 311 of another one of the two adjacent ones of the cover plates 31 are aligned along an axis (L), and each of the pivot shafts 32 is inserted into the aligned connecting barrels 312 of two adjacent ones of the cover plates 31.

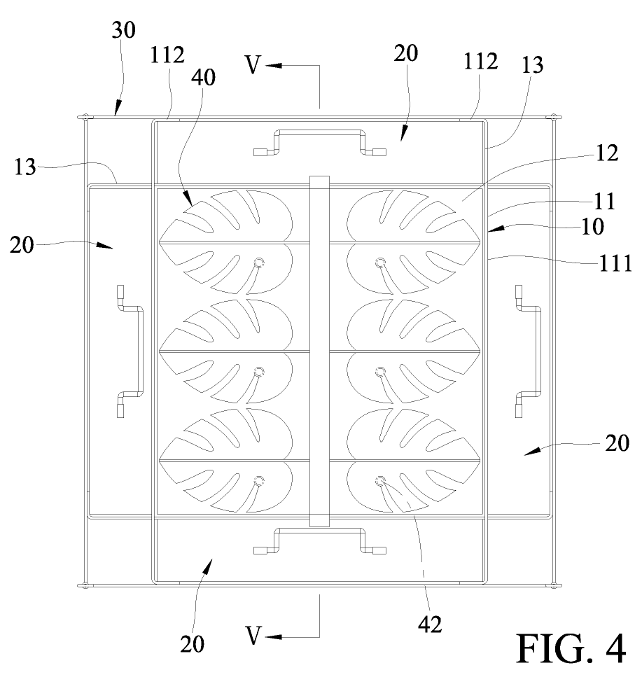

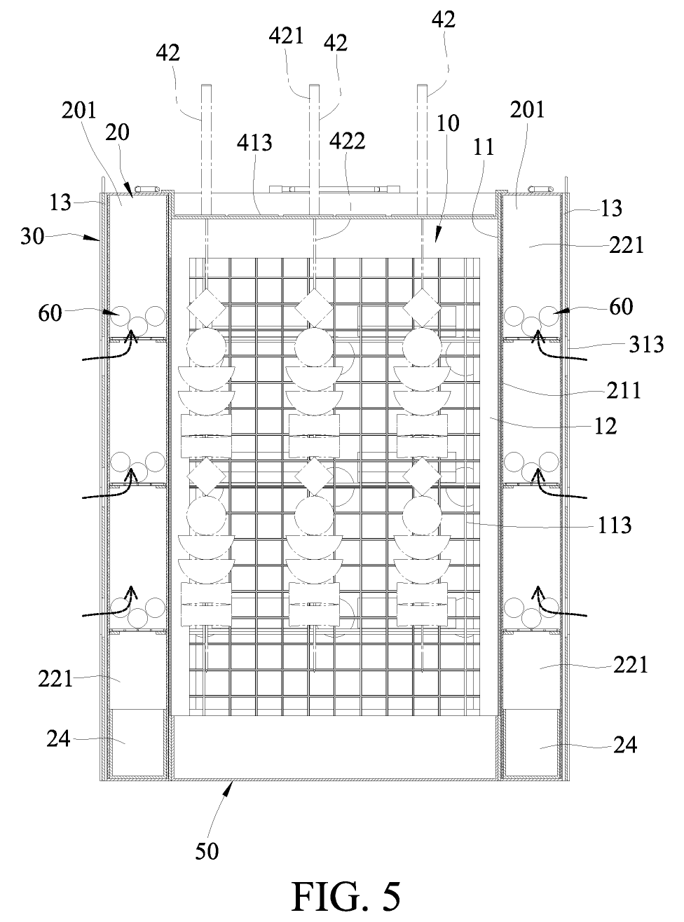

Referring to FIGS. 4 and 5, the hanging unit 40 is disposed on the furnace frame unit 10 and includes a main hanger 41 that straddles two of the frame boards 11 which are spaced apart, and a plurality of spit rods 42 that are disposed removably on the main hanger 41. The main hanger 41 has a horizontal rod 411 and a plurality of wing plates 412 that are connected to the horizontal rod 411. Each of the wing plates 412 has a plurality of slide grooves 413, and has a leaf-like shape. The slide grooves 413 of each of the wing plates 412 have shapes of leaf veins, are adapted for the spit rods 42 to inserted therethrough. Each of the spit rods 42 has a handle portion 421 that abuts against a respective one of the wing plates 412, and a rod portion 422 that is connected to the handle portion 421 and that extends into the accommodation space 12.

The oil collection tank 50 is disposed at a bottom portion of the accommodation space 12.

To further understand the functions of the components, the applied techniques, and the expected effects of the present disclosure, the following is a detailed explanation. It is believed that a deeper and more specific understanding of the present disclosure can be obtained from this.

Referring to FIGS. 1, 2, and 3, when assembling the cooking device, each of the frame boards 11 is connected to an adjacent one of the frame boards 11 by being inserted into one of the insert grooves 117 of the adjacent one of the frame boards 11, so that the frame boards 11 form a pound sign shape (i.e., #) when viewing from the top (see FIG. 4).

At this time, referring to FIG. 4 and FIG. 5, the frame boards 11 are interconnected to form four outer spaces 13 at outer sides thereof, and the charcoals 60 may be placed in the accommodating chambers 221. Next, the ash box 24 of each of the fuel rack sets 201 is mounted in the one of the accommodating chambers 221 of the fuel rack sets 201 that is located at the bottommost portion of the fuel chamber 22. After lighting the charcoals 60, the fuel rack sets 201 are respectively inserted into the outer spaces 13 formed by the frame boards 11.

Next, the shielding unit 30 surrounds the furnace frame unit 10 and the fuel rack units 20, and oxygen is provided via the vent holes 313 and the corresponding ones of the mesh holes 25 for combustion of the charcoals 60 (as indicated by the dashed arrows in FIG. 5). Moreover, by virtue of the shielding unit 30 surrounding the furnace frame unit 10 and the fuel rack units 20, flames or ashes from the fuel rack units 20 are prevented from being randomly spread outward or toward the accommodation space 12. However, heat energy generated by the combustion of the charcoals 60 in the fuel rack units 20 may pass through the side frame members 211 and the net bodies 113, and enter the accommodation space 12.

As shown in FIG. 4 and FIG. 5, when foods are skewered onto the spit rods 42, and the rod portions 422 of the spit rods 42 are inserted into the slide grooves 413, the handle portions 421 of the spit rods 42 are abutted against corresponding ones of the wing plates 412, thereby allowing the spit rods 42 and the foods to be stably hanging in the accommodation space 12 and be cooked by the heat energy produced by the combustion of the charcoals 60.

When the foods skewered on the spit rods 42 produce juice and oil when heated, or when sauce coated onto the foods start to drip, the juice, the oil, and the sauce may be collected by the oil collection tank 50, and the juice and the oil do not drip onto the charcoals 60, so smoke may be reduced.

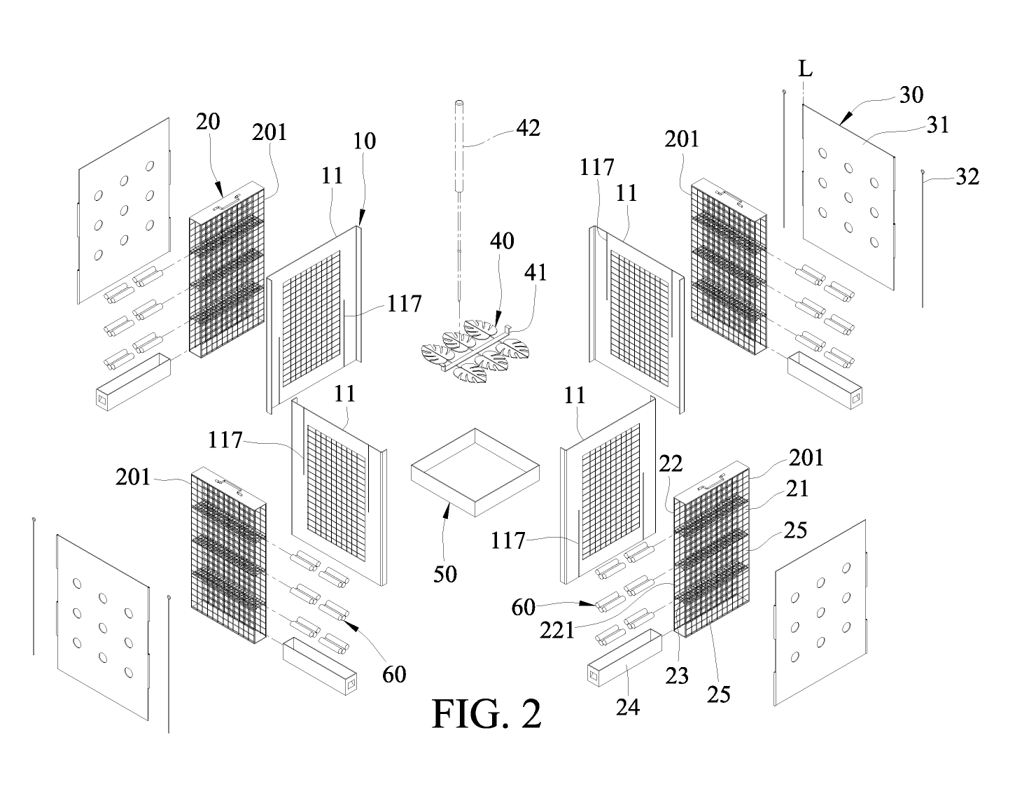

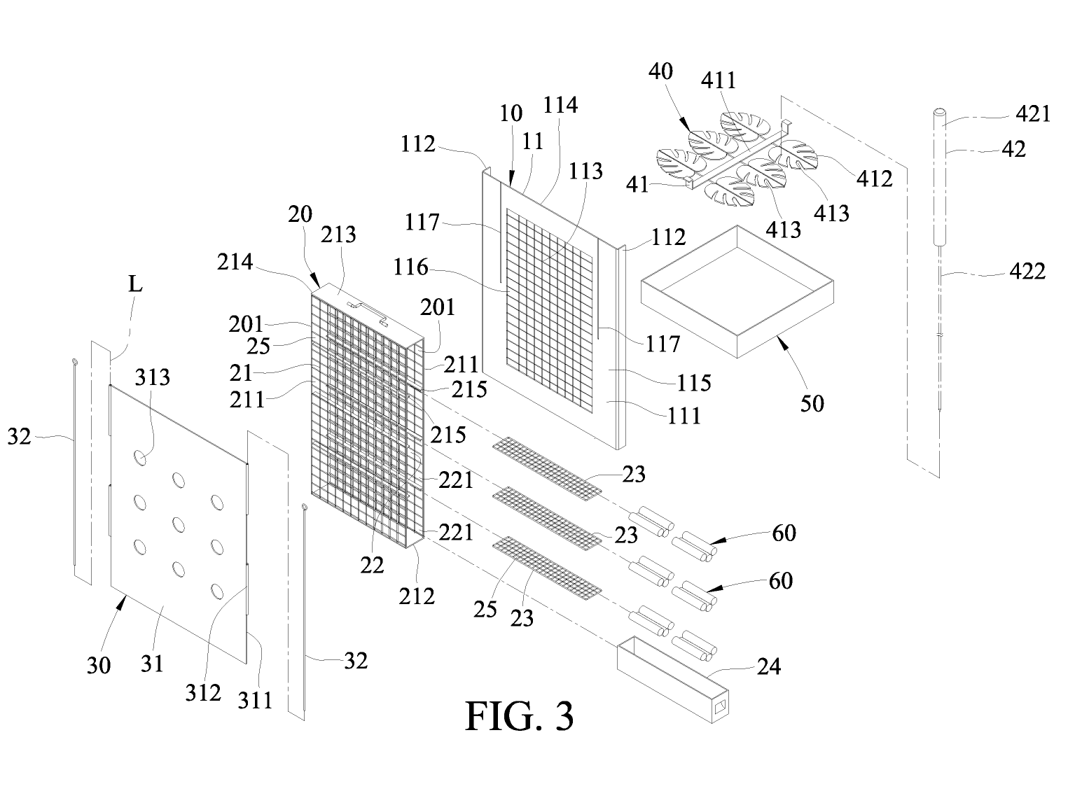

It should be noted that, by virtue of the frame boards 11, the cover plates 31, and the pivot shafts 32 being detachable, the cooking device occupies less space when not in use, and transportation cost thereof may be reduced. Moreover, each of the side frame members 211, the bottom plate members 212, the top plate members 213, and the back panel members 214 of the surrounding walls 21 may be designed to be pivotally connected to each other, so that each of the surrounding walls 21 may be converted between a folded state (not shown in the drawings, i.e., two side frame members 211 are close to each other) and an unfolded state (as shown in FIG. 2 or FIG. 3), which may further reduce the space occupied.

As described above, the cooking device of the present disclosure has a simple structure, is easy to manufacture and assemble, and may reduce the production of smoke, thereby effectively achieving the object of the disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A cooking device, comprising:
a furnace frame unit including a plurality of frame boards that are interconnected with each other, said frame boards cooperatively defining an accommodation space, each of said frame boards having an inner side surface, an outer side surface that is opposite to said inner side surface, and a penetrating region that communicates said inner side surface and said outer side surface;
a fuel rack unit including a plurality of fuel rack sets each of which is disposed on said outer side surface of a respective one of said frame boards, each of said fuel rack sets having
a surrounding wall, a fuel chamber that is formed by said surrounding wall, a plurality of frame separators, and an ash box that is detachably mounted on said surrounding wall and that is located at a bottom portion of said fuel chamber, said surrounding wall of each of said fuel rack sets including two side frame members, a bottom plate member that interconnects said side frame members, a top plate member that interconnects said side frame members, and a back panel member that interconnects said side frame members, said bottom plate member and said top plate member, each of said side frame members of said surrounding wall of each of said fuel rack sets having a plurality of support members that are disposed spaced apart, said frame separators of each of said fuel rack sets straddling said side frame members of said surrounding wall of said fuel rack set, each of said frame separators of each of said fuel rack sets being disposed on one of said support members of one of said side frame members of said fuel rack set and a respective one of said support members of another one of said side frame members of said fuel rack set that is aligned with said one of said side frame members, said frame separators of each of said fuel rack sets dividing said fuel chamber of said fuel rack set into a plurality of accommodating chambers, one of said accommodating chambers of each of said fuel rack sets that is located at a bottommost portion of said fuel chamber of said fuel rack set allowing said ash box of said fuel rack set to be detachably mounted thereto, said side frame members and said frame separators being meshed, each of said side frame members and said frame separators having a plurality of mesh holes; and
a shielding unit surrounding said furnace frame unit and said fuel rack unit, and including a plurality of cover plates that are interconnected with each other and that are respectively disposed on outer sides of said fuel rack sets, each of said cover plates having a plurality of vent holes that are in spatial communication with corresponding ones of said mesh holes of a corresponding one of said side frame members.

2. The cooking device as claimed in claim 1, further comprising a hanging unit that is disposed on said furnace frame unit, said hanging unit including a main hanger that straddles two of said frame boards which are spaced apart from each other, and at least one spit rod that is disposed removably on said main hanger, said at least one spit rod being extendable into said accommodation space.

3. The cooking device as claimed in claim 2, wherein said main hanger of said hanging unit includes a horizontal rod, and a plurality of wing plates that are connected to said horizontal rod, each of said wing plates having a plurality of slide grooves, each of said slide grooves being for said at least one spit rod to insert therethrough, said at least one spit rod having a handle portion that abuts against one of said wing plates, and a rod portion that is connected to said handle portion and that extends into said accommodation space.

4. The cooking device as claimed in claim 3, wherein each of said wing plates of said hanging unit has a leaf-like shape, and said slide grooves of each of said wing plates have shapes of leaf veins.

5. The cooking device as claimed in claim 1, wherein each of said frame boards of said furnace frame unit has two insert grooves that are respectively provided on two sides of said penetrating region, a number of said frame boards being four, said insert grooves of two of said frame boards that are opposite to each other having openings that face downward, said insert grooves of another two of said frame boards that are opposite to each other having openings that face upward, each of said frame boards being connected to an adjacent one of said frame boards by being inserted into one of said insert grooves of said adjacent one of said frame boards.

6. The cooking device as claimed in claim 5, wherein each of said frame boards of said furnace frame unit has a plate body, two bent portions that are integrally connected to said plate body, and a net body that is connected to said plate body, said penetrating region being disposed on said plate body, said net body being disposed on said penetrating region, any three adjacent ones of said frame boards cooperatively defining an outer space that is located at one side of a middle one of said three adjacent ones of said frame boards opposite to said accommodation space when said frame boards are interconnected with each other such that said frame boards cooperatively defining a plurality of said outer spaces, one of said bent portions of each of another two of said three adjacent ones of said frame boards that are opposite to each other being located at an outer opening of said outer space distal from said accommodation space, said fuel rack sets being detachably and respectively inserted into said outer spaces.

7. The cooking device as claimed in claim 1, wherein each of said cover plates of said shielding unit has two side edges and a plurality of connecting barrels that are disposed on said side edges, said connecting barrels on one of said side edges of one of any two adjacent ones of said cover plates and said connecting barrels on one of said side edges of another one of said two adjacent ones of said cover plates being aligned along an axis, said shielding unit further including a plurality of pivot shafts each of which is inserted into said connecting barrels of two adjacent ones of said cover plates that are aligned.

8. The cooking device as claimed in claim 1, further comprising an oil collection tank, said oil collection tank being disposed at a bottom portion of said accommodation space.
